(19) United States
(12) Patent Application Publication
(10) Pub. No.: US 2025/0083350 A1
(43) Pub. Date: Mar. 13, 2025

(54) BOX CUTTER WITH DUAL-ACTION SAFETY

(71) Applicant: Charles Kinkaid, Louisville, KY (US)

(72) Inventor: Charles Kinkaid, Louisville, KY (US)

(21) Appl. No.: 18/804,919

(22) Filed: Aug. 14, 2024

Related U.S. Application Data
(60) Provisional application No. 63/532,533, filed on Aug. 14, 2023.

(51) Int. Cl. B26B 29/02; B25G 1/08; B25G 1/10; B26B 5/00

(52) U.S. Cl. CPC B26B 29/02; B25G 1/08; B25G 1/102; B26B 5/00

(57) ABSTRACT

A box cutter having a dual-action safety mechanism comprising a movable blade guard, a guard-release button, and a mechanism linking the two. Disengagement of the safety mechanism requires a box to be registered against the box cutter on two faces. As the cutter moves along the edge of a box the guard-release button is depressed, allowing the movable blade guard to be rotated into the housing of the box cutter, revealing the blade and allowing for a cut. Once the cutting operation is complete the button is released, and the movable blade guard automatically reengages to a position in which it is locked over the blade.

### CROSS REFERENCES AND RELATED APPLICATIONS

This application claims priority from provisional application 63/532,533 filed on Aug. 14, 2023 and is incorporated by reference in its entirety.

### TECHNICAL FIELD

The present invention relates to bladed implements that open boxes, such as corrugated cardboard boxes. More particularly, the present invention relates to those bladed implements which include blade guards to minimize a user's risk of injury.

### BACKGROUND OF THE INVENTION

Box cutters are a common and useful tool for opening containers, including cardboard boxes, which store and transport products and objects. Cardboard is an ideal material for packaging due to its low cost, low weight, customizability, and recyclability. The high strength-to-weight ratio of cardboard can often be attributed to a corrugated construction. Cardboard packaging may be used to contain a single product or as an overpack for multiple smaller boxes. Further, sheets of cardboard can be mounted around a rigid framed structure to provide the walls necessary to protect the contents held within the structure. As such, the sizes of cardboard boxes are highly variable, ranging from only several cubic inches to many cubic feet. Typically, the cardboard walls of these boxes are found in thicknesses of ⅛ inch to ¼ inch.

Common methods to ensure that the contents of a packing box are securely held inside during transport include taping, gluing, plastic shrink wrapping, and even stapling. Often, the same attention and planning that goes into properly packing a product into a box also makes it more difficult to open, even with a sharp implement such as a knife or box cutter. Consequently, the frequency of hand injuries from box cutters is significant, particularly in workplaces with high package throughputs. A single hand laceration from a box cutter can cost from hundreds to thousands of dollars in medical expenses and lost time.

The term box cutter—also known as a utility knife, razor blade knife, and retractable blade knife, among others—is used herein to refer to an implement having a sharp blade, often a razor blade, that is used for cutting cardboard and opening boxes. A standard box cutter includes two primary components, namely a handle and a blade. Commonly, the blade is housed within the handle when the cutter is not in use and can be extended either partially or fully from the handle when in use.

In general, safety standards for box cutters require the blade to have some sort of guard when not in use, such as a blade which can be retracted into the handle. However, because in practice many box cutters have no guard over the blade when the box cutter is in use, carelessness and other factors can lead to injuries such as lacerations or severed digits. Especially in workplaces where many packages are handled, such as factories, the sheer number of boxes that need to be opened provides ample opportunity for accidents to occur; often exacerbated by the working conditions wherein a worker may feel fatigued, stressed, or hurried.

Furthermore, when a large volume of packages is being opened there is another consideration of blades becoming worn, making them ineffective for the task of box opening. At worst, a worn blade increases the likelihood of a hand laceration. When a person uses a worn or dull blade more force is required to achieve a cut; leading to an operator having less control over the blade and prone to slip. This issue is worsened by the frustration that a dull blade presents.

Another common problem can arise from a deformity in the box, particularly close to the edges where a person would seek to cut the box to open it. These deformities can occur during shipping or by having objects dropped upon the box, for example. Conversely, it generally is easier to open a box when the cardboard at all the edges and corners is smooth and level. In practice, a deformity makes the worker take the blade away from the box, at least momentarily, before applying force and reinitiating contact elsewhere upon the box as the opening process continues. These transitions are another point at which hand lacerations can occur through lack of attention, too much force being used, and insufficient control over the box.

Knife safety approaches to overcome these problems have included educational interventions of practical techniques such as cutting away from the body, wearing thick gloves, and retracting the blade when not in use. Nonetheless, these and other conventional approaches have not been successful in reducing the incidence of box cutter injuries to a satisfactory degree.

Additionally, especially in the case of frequent use, conventional box cutters can result in carpal tunnel syndrome, tendinitis, and other repetitive motion injuries. At a minimum, most box cutters require a significant level of hand strength to maintain the grip on the body of the box cutter for any significant length of time and for frequent uses. This can lead to fatigue, including around the thumb and index finger area. Over time, this can produce repetitive motion injuries, or an increased likelihood of loss of control of the knife as the hand becomes more fatigued, again leading to lacerations and cutting injuries from the sharp blade.

What is desired, therefore, is a box cutter which provides an ergonomic grip which reduces the amount of hand strength required to cut and open boxes. What is further desired is a box cutter which provides a redundancy in the safety guards between the blade and the user, and in which worn blades can be replaced with ease.

### SUMMARY OF THE INVENTION

Accordingly, it is an object of the present invention to provide a box cutter having a safety mechanism which automatically covers the blade when not in use and requires a box to be registered against the cutter before the safety mechanism is released. Additionally, it is an object of the invention that the safety mechanism reengages immediately following a cutting operation.

It is another object of the invention to provide a box cutter having an ergonomic grip which allows a user to operate the cutter with the primary muscle groups of the arm to cut a box instead of relying upon the tendons and ligaments of the wrist.

It is yet another object of the invention to provide a box cutter which has interchangeable blades which can easily be set at various depths.

To overcome the deficiencies of the prior art and to achieve at least some of the objectives and advantages listed, herein is disclosed a dual-action safety box cutter comprising a housing, a blade, and a safety mechanism. The housing includes a base and a fence perpendicular to the base which are used to register the cutter against the edge of a box. Extending from the back side of the base is a handle intended to be gripped in the palm of a user, so that the user may pull the cutter in the direction of operation using their bicep.

Internal to the housing, a safety mechanism comprises a movable blade guard, a guard-release button, a safety jam, and a catch protruding from the safety jam. The guard-release button protrudes from the base of the housing with a ramp pointed towards the direction of motion. The blade of the cutter protrudes from the base positioned behind the guard-release button, with the sharp end facing the direction of motion. The movable safety guard protrudes from the fence of the housing and rotates outward to shield the blade so that a user cannot accidentally cut themselves. The movable safety guard also includes a ramp pointed towards the direction of motion.

When a user intends to operate the dual-action safety box cutter, the cutter must be registered against the edge of the box at the leading end and then pulled along the edge of the box. The engagement of the cutter begins when the box depresses the guard-release button, which lowers the safety jam so that the catch does not impede the movement of the movable blade guard. As the cutter continues along the box, it contacts the ramp of the movable blade guard and rotates it into the cutter, thereby revealing the blade and allowing the cut to be made. Once the cutter has finished cutting, the guard-release button is automatically released and the movable blade guard snaps back over the blade.

There has thus been outlined, rather broadly, the more important features of this invention in order that the detailed description thereof that follows may be better understood, and in order that the present contribution to the art may be better appreciated. There are, of course, additional features of the invention that will be described hereinafter and which will form the subject matter of the claims appended hereto.

### BRIEF DESCRIPTION OF DRAWINGS

The accompanying drawings are incorporated into and form a part of the specification to illustrate examples of the aspects, embodiments, or configurations disclosed herein. The drawings together with the description, are meant to explain the principal aspects, embodiments, or configurations of the invention. The drawings illustrate preferred and alternative examples of the aspects, but are not intended to limit the aspects, embodiments, or configurations to only the illustrated and described examples. Further features and advantages will become apparent from the following, more detailed, description of the various aspects, embodiments, or configurations, as illustrated by the drawings referenced below. Reference numbers are the same for those elements that are the same across different Figures.

FIG. 1 is a perspective view of the back side of a first embodiment of a dual-action safety box cutter.

FIG. 2 is a perspective view of the bottom side of the first embodiment of a dual-action safety box cutter of FIG. 1.

FIG. 3 is a perspective view of a user holding a dual-action safety box cutter.

FIG. 4 is an exploded view of a safety mechanism of the first embodiment of a dual-action safety box cutter of FIG. 1.

FIG. 5 is a detailed view of a safety box of the safety mechanism of the first embodiment of a dual-action safety box cutter of FIG. 1.

FIG. 6 is a detailed view of an alternative safety box of the safety mechanism of the first embodiment of a dual-action safety box cutter of FIG. 1.

FIG. 7 is a perspective view of the movable blade guard of the first embodiment of a dual-action safety box cutter of FIG. 1.

FIG. 8 is a perspective top view of a safety jam of the safety mechanism of the first embodiment of a dual-action safety box cutter of FIG. 1.

FIG. 9 is a perspective bottom view of a safety jam of the safety mechanism of the first embodiment of a dual-action safety box cutter of FIG. 1.

FIG. 10 is an exploded assembly view of the first embodiment of a dual-action safety box cutter of FIG. 1.

FIG. 11 is a plan view of the front side of the first embodiment of a dual-action safety box cutter of FIG. 1.

FIG. 12 is a cross-sectional view of the safety mechanism of the first embodiment of a dual-action safety box cutter of FIG. 1 in an engaged configuration.

FIG. 13 is a cross-sectional view of the safety mechanism of the first embodiment of a dual-action safety box cutter of FIG. 1 in a disengaged configuration.

FIG. 14 is a perspective view of the bottom side of the first embodiment of a dual-action safety box cutter of FIG. 1 being registered against a box for cutting.

FIG. 15 is a perspective view of a cross section of the first embodiment of a dual-action safety box cutter of FIG. 1 demonstrating the disengagement of the safety mechanism when being used to cut a box.

FIG. 16 is a perspective view of a second embodiment of a dual-action safety box cutter having a blade storage compartment.

FIG. 17 is a perspective view of a third embodiment of a dual-action safety box cutter optimized for injection molding.

FIG. 18 is a perspective view of the internal side of the top cover of the third embodiment of a dual-action safety box cutter of FIG. 17.

FIG. 19 is a plan view of the external side of the back cover of the third embodiment of a dual-action safety box cutter of FIG. 17.

FIG. 20 is a perspective view of the internal side of the bottom cover of the third embodiment of a dual-action safety box cutter of FIG. 17.

FIG. 21 provides a front and rear perspective view of an optimized safety box according to the third embodiment of a dual-action safety box cutter of FIG. 17.

FIG. 22 is a perspective view of the bottom cover of a fourth embodiment of a dual-action safety box cutter having a safety override slot.

FIG. 23 is a perspective view of the safety jam according to the fourth embodiment of a dual-action safety box cutter of FIG. 22.

FIG. 24 is a perspective top view of an alternative embodiment of the safety jam of the safety mechanism of the first embodiment of a dual-action safety box cutter of FIG. 1.

### DETAILED DESCRIPTION OF THE INVENTION

Various embodiments of the present invention are described herein and depicted in the drawings. To acquaint persons skilled in the pertinent arts most closely related to the present invention, a preferred embodiment that illustrates the best mode now contemplated for putting the invention into practice is described herein by, and with reference to, the annexed drawings that form a part of the specification. This exemplary embodiment is described in detail without attempting to describe all the various forms and modifications in which the invention might be embodied. As such, the embodiments described herein are illustrative and, as will become apparent to those skilled in the arts, may be modified in numerous ways within the scope and spirit of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature structure, or characteristic in connection with other embodiments, whether or not explicitly described.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” or “an”, “one or more” and “at least one” can be used interchangeably herein.

The use of “including,” “comprising,” or “having,” and variations thereof herein is meant to encompass the items listed thereafter and equivalents thereof as well as additional items. Accordingly, the terms “including,” “comprising,” or “having,” and variations thereof can be used interchangeably herein.

It shall be understood that the terms “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

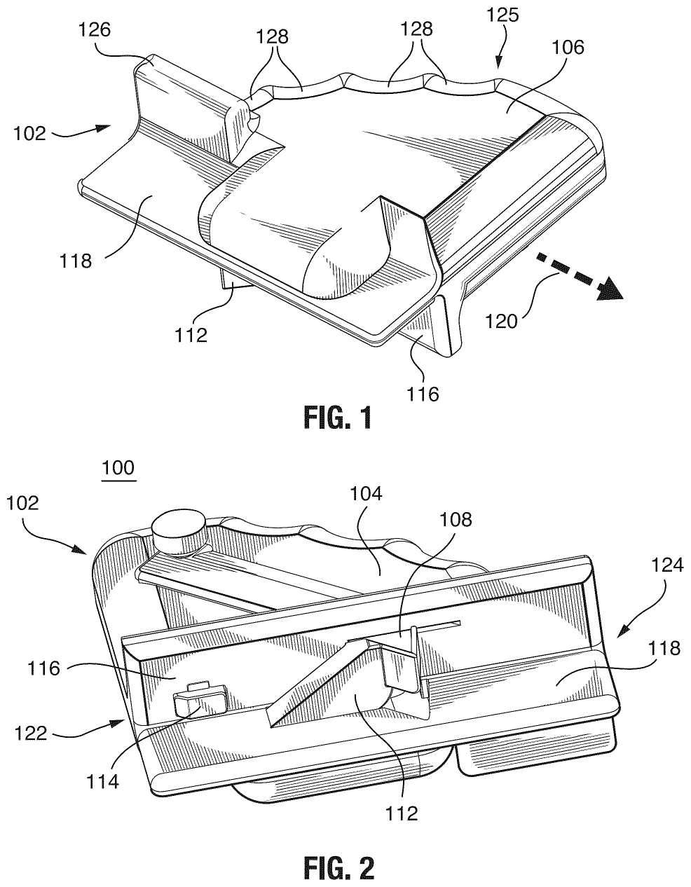

Referring now to FIG. 1 and FIG. 2, a preferred embodiment of a dual-action safety box cutter 100 is shown with the safety mechanism in an engaged configuration E. The dual-action safety box cutter comprises a housing 102 having a top cover 104 and a bottom cover 106, a blade 108, and a safety mechanism 110 including a movable blade guard 112 and a guard-release button 114. The top cover 104 includes a set of perpendicular guides, herein referred to as the base 116 and the fence 118, which are used to register the box cutter 100 against the corner of a box 50. As illustrated in FIG. 2, the blade 108 and the guard-release button 114 protrude from the base 116 while the movable blade guard 112 protrudes from the fence 118. The direction of operation 120 of the box cutter is indicated by an arrow. As such, the base and fence have a leading end 122 and a trailing end 124.

The housing 102 serves multiple functions, as it not only encases the safety mechanism and blade of the box cutter, but also provides a means for aligning the box cutter with a box and includes an ergonomic means by which to hold the box cutter. Opposite of the base 116, the housing 102 extends outward in an arc which serves as an ergonomic handle 125 for the user. The tall side of the handle is proximate to the leading end 122 of the box cutter and the low side of the handle is proximate to the trailing end 124 of the box cutter. Parallel to the base, a thumb rest 126 extends outward from the bottom cover 106 at the low side of the handle. The arced ridge of the handle includes finger placement depressions 128 to increase the grip of the user.

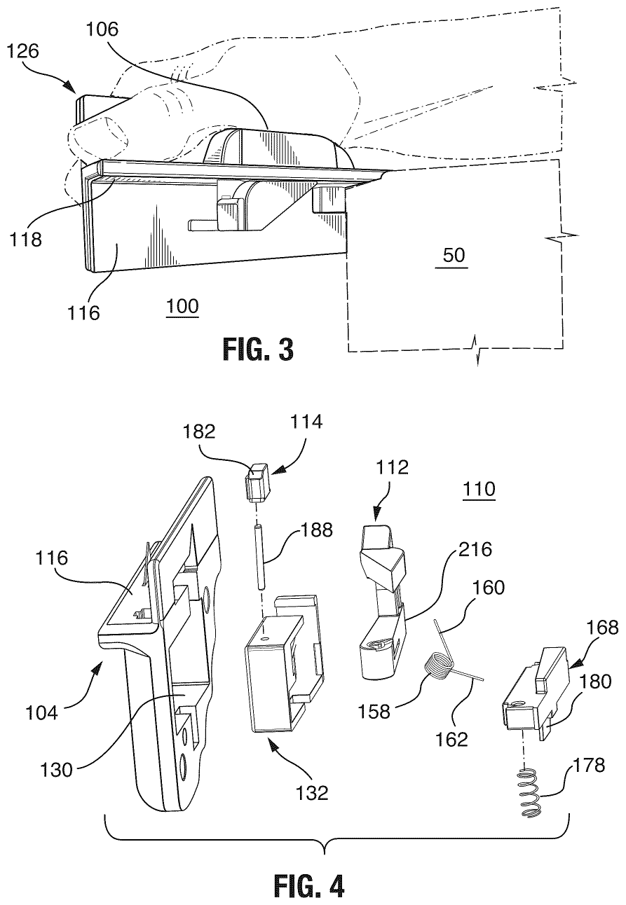

As illustrated in FIG. 3, the box cutter 100 fits into the hand of a user so that the palm of a user abuts the bottom cover 106, the fingers of the user can wrap around each of the finger placement depressions 128, and the user's thumb is able to rest or press against the thumb rest 126 during use. The arcing extension of the handle 125 provides a grip for the box cutter which allows for the wrist to remain straight during cutting operations, thereby reducing the strain induced on the wrist compared to a conventional box cutter. Further, maintaining a straightened wrist allows the user to exert force on the cutter with primarily the biceps and shoulders, reducing the risk of fatigue or repetitive motion injuries of the wrist. A further advantage of this grip design, made apparent in the illustration, is that the user's hand is placed opposite of the base 116 and the fence 118, thereby protecting the user from being cut by either the blade or the edges of the packaging. While the current embodiment depicts a right-handed box cutter, it will be appreciated that an equivalent left-handed box cutter may be created by mirroring each component.

The safety mechanism 110 of the box cutter 100 is predominantly internal to the housing 102, with only the movable blade guard 112 and the guard-release button 114 protruding from the covers. Internally, the housing contains a cavity 130, illustrated in the exploded view of FIG. 4, in which the safety mechanism 110 nests.

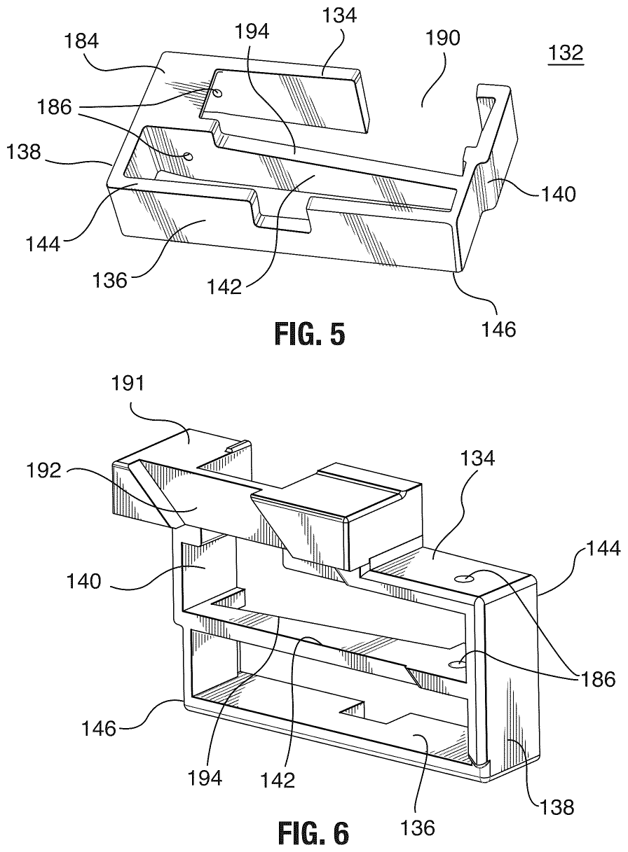

The safety mechanism 110 includes a rigid frame, herein referred to as the safety box 132, which acts as central nexus of each other component of the safety mechanism and their relationship to the blade 80. The safety box 132, illustrated in detail in FIG. 5, includes a top wall 134, a bottom wall 136, a left wall 138, a right wall 140, and a dividing wall 142 parallel to, and between, the top and bottom walls. The top wall 134 may have a cut-out section 190 reserved for accommodating the movable blade guard 112, or may have an offset bracing member 191, as shown in FIG. 6. In the alternative embodiment, the offset bracing member 191 may further include an angled guideway 192 through which a blade 80 may pass. The front face 144 of the safety box 132 faces the bottom cover 106 of the box cutter, and the back face 146 of the safety box faces the top cover 104 of the box cutter when inserted into the cavity 130. A brief description of the other components of the safety mechanism will now be given individually followed by an explanation of how the mechanism is assembled.

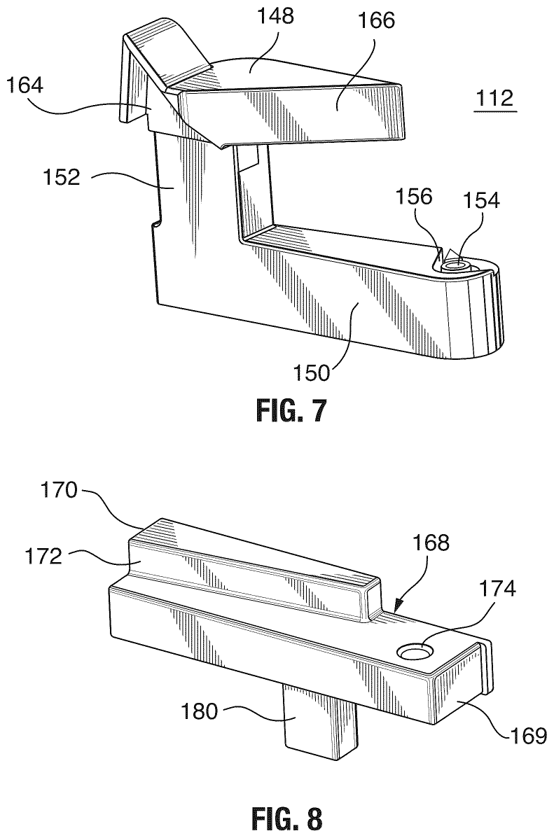

The movable blade guard 112, illustrated in FIG. 7, is shaped as a “C”, with a top arm 148 and a bottom arm 150 connected by a vertical member 152. The bottom arm 150 includes a thru-hole 154 at its distal end through which an axle may be inserted and pivoted about. A retaining groove 156 for holding a first end 160 of a torsion spring 158 is concentric with the thru-hole 154. The top arm 148 of the movable blade guard 112 is thickened at its junction with the vertical member 152. Proximate to the vertical member, the top arm 148 is shelled to create a blade receptacle 164 into which the blade 108 is engulfed when the safety mechanism is in an engaged configuration E. The blade receptacle may extend beyond the top face of the top arm 148 to accommodate for various blade length settings. The distal end of the top arm 148 tapers to form a ramp 166.

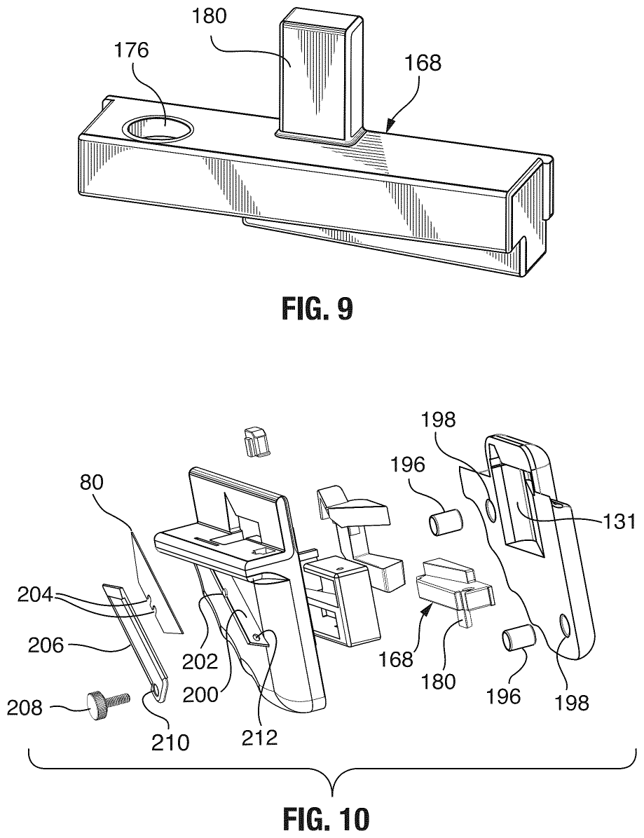

The safety jam 168, illustrated in FIG. 8 and FIG. 9, provides the means by which the movable blade guard 112 is prevented from opening. The thickness of the base 169 of the safety jam 168 is less than the distance between the dividing wall 142 and the bottom wall 136 of the safety box 132. A catch 170 protrudes from the top side of the base of the safety jam. The front side 172 of the catch 170 may be angled to match a taper on the bottom arm 150 of the movable blade guard 112. The top side of the base 170 also includes a first indent 174 for receiving and interacting with the end of an axle, rod or spindle. On the bottom side of the base, a second indent 176 is included for receiving and locating a compression spring 178. Further, a guide rod 180 extends from the bottom side of the base to help ensure the safety jam translates in a linear motion.

The safety mechanism 110 further includes a guard-release button 114 which protrudes from the base 116 of the top cover 104. The top side of the button 114 includes a ramp 182. The bottom side of the button 114 includes a receptacle (not illustrated) which is appropriately sized to receive the end of an axle, rod, or shaft.

In assembly of the safety mechanism, the bottom arm 150 of the movable blade guard 112 is positioned between the top wall 134 and dividing wall 142 of the safety box 130 with the distal end of the bottom arm proximate to the left wall 138 of the safety box 132. A biasing wall 184 extends inward from the left wall 138 of the safety box 132 between the top wall 134 and dividing wall 142. Prior to the insertion of the bottom arm of the movable blade guard, the first end 160 of the torsion spring 158 is inserted into the retaining groove 156 and wound so that the second end 162 of the torsion spring 158 is biased against the biasing wall 184 and therefore applies a rotational force upon the movable blade guard 112 so that the guard is disposed to protruding from the fence 118 of the top cover 104, either through the cut-out section 190 or towards the offset bracing member 191. A set of thru-holes 186 extending through the top wall 134 and the dividing wall 142 receives an axle 188 which also passes through the thru-hole 154 of the bottom arm 150, thereby locating the movable blade guard 112 and constraining its linear motion.

The safety jam 168 is positioned between the dividing wall 142 and the bottom wall 136 so that the catch 170 faces upward towards the dividing wall and the first indent 174 is concentric with the set of thru-holes 186 so as to receive the bottom-facing side of the axle 188. The compression spring 178 is positioned between the bottom facing side of the safety jam and the bottom wall, located by the second indent 176 of the safety jam. The dividing wall 142 includes an appropriately shaped notch 194 through which the catch 170 may pass through and extend beyond the dividing wall so to prevent the movable blade guard 112 from being rotated.

The axle 188 is of a length which slightly protrudes from the top wall 134, and either flush or slightly proud of the bottom facing side of the dividing wall 142 when inserted. The top-facing side of the axle 150 may be inserted into the appropriately sized receptacle located on the bottom side of the guard-release button 114, and the bottom-facing side of the axle 150 located in the first indent 174 of the safety jam 168. Alternatively, the guard-release button 114 may not contain a receptacle for receiving the top-facing side of the axle 150, and, instead, the axle may interface with a flush bottom face of the guard release button.

After the safety mechanism 110 is inserted into the cavity 130 of the top cover 104, the top cover and bottom cover 106 may be joined. To assist in alignment of the two halves, means such as dowels 196 and dowel holes 198, illustrated in FIG. 10, flanges, a lip and groove joint, or other locating features may be used. The top and bottom covers may be joined by screws, bolts, adhesives, press fits, snap fits, and the like.

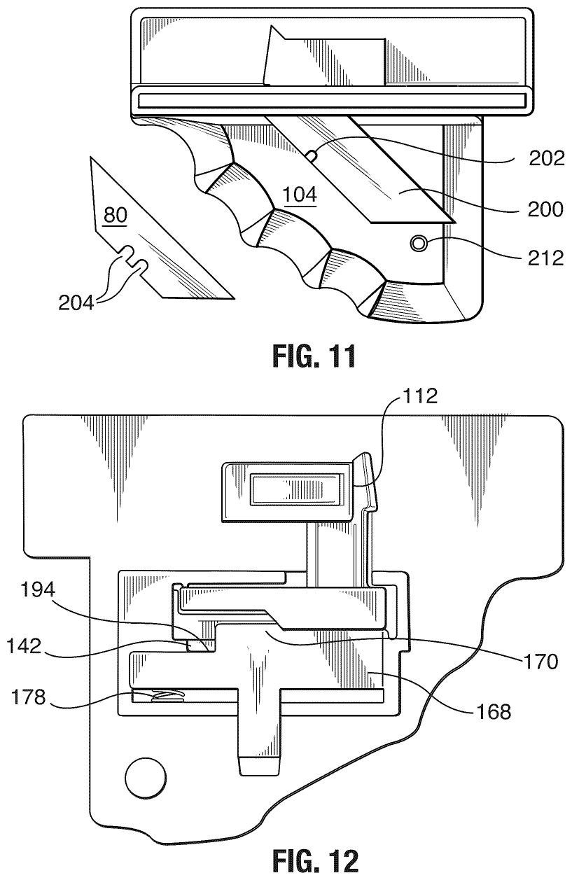

A blade-shaped recess 200 is debossed in the external wall of the top cover 104, for containing the body of the blade 80. An alignment pin 202 protrudes from a side wall of the blade-shaped recess to interlock with an at least one alignment groove 204 cut into the blade. In the preferred embodiment, the blade has at least two alignment grooves by which a user may adjust the depth of a cut by interlocking the blade with the alignment pin at various groove locations, as illustrated in FIG. 11. When a blade 80 is inlaid into the blade-shaped recess 200, a blade cover 206 may be placed over the blade and attached to the housing 102 to ensure the blade is safely secured. In the preferred embodiment, a thumb screw 208 may be inserted through a hole 210 of the blade cover 206 and fastened to threads 212 which may be integrally molded or machined into the top cover 104.

As assembled, the dual-action safety box cutter 100 defaults to an engaged configuration E whereby the safety mechanism covers the blade and prevents a user from an accidental injury. The internal mechanism in an engaged configuration E is illustrated in FIG. 12. As shown, the compression spring 178 biases the safety jam 168 against the dividing wall 142 so that the catch 170 extends beyond the dividing wall through the notch 194 and prevents the movable blade guard 112 from rotating inward and exposing the blade 80.

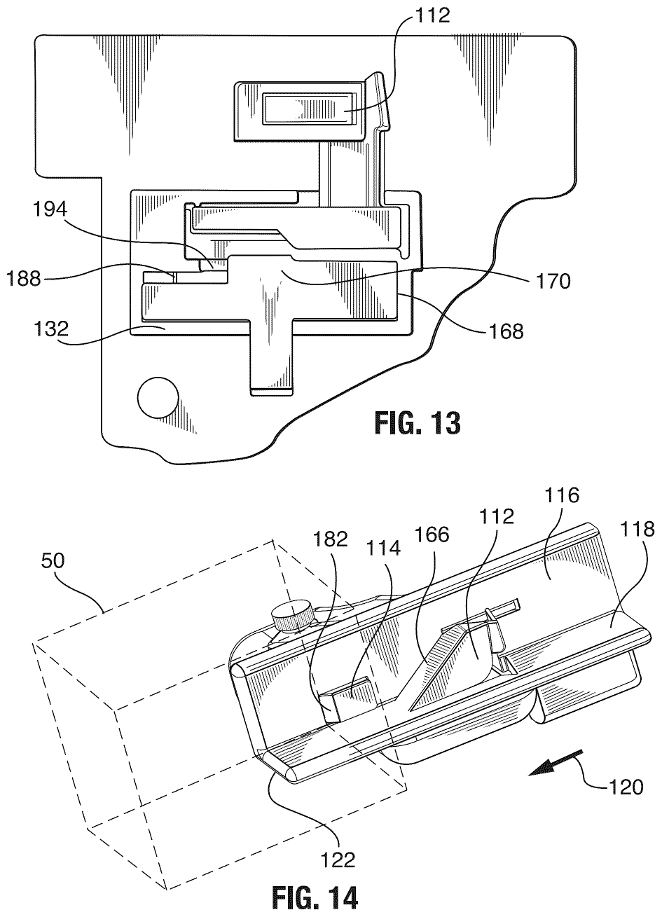

The internal mechanism in a disengaged configuration D is further illustrated in FIG. 13. When the box depresses the guard-release button 114, the bottom of the button translates the axle 188 towards the bottom of the safety box 132, thereby pushing the safety jam 168 downward so that the catch 170 no longer extends beyond the dividing wall 142 through the notch 194. Without the catch immobilizing the movable blade guard 112, as the box 50 moves along the fence 118, the movable blade guard can be rotated inwards.

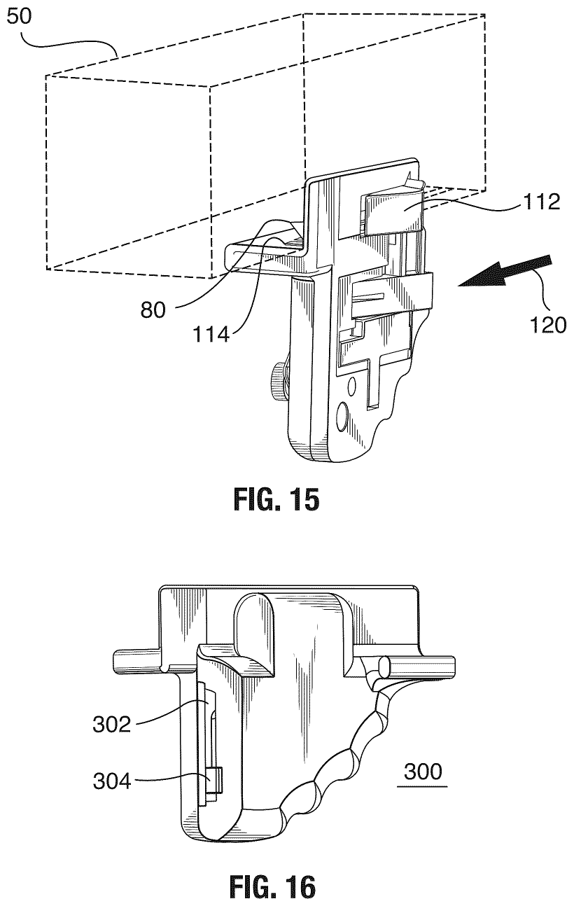

To operate the box cutter 100, a user must register the edge of a box 50 against the leading end 122 of the base 116 and the fence 118 as illustrated in FIG. 14. As the box cutter is moved along the edge of the box in the direction of operation 120, the face of the box in contact with the base of the box cutter eventually contacts the ramp 182 of the guard-release button 114, depressing the button as the cutter continues in the direction of operation until the button is flush with the base 116 of the cutter. Once the button 114 is sufficiently depressed, the safety mechanism 110 becomes disengaged and, as the cutter continues in the direction of operation 120, the face of the box in contact with the fence 118 of the cutter eventually contacts the ramp 166 of the movable blade guard 112, causing the guard to rotate into the body of the cutter, into the hollow 131, and reveal the blade 80 which may then cut along the edge of the box, as illustrated in FIG. 15. Once the box cutter 100 clears the box 50, the torsion spring 158 snaps the movable blade guard 112 back over the blade 80 and the safety jam 168 moves back to an engaged position since the guard-release button 114 is no longer depressed.

A single embodiment has been illustrated thus far to describe the fundamental elements, the relationship between elements, and the method of operation of the dual-action safety box cutter 100. Further embodiments will now be considered.

In a second embodiment of a dual-action safety box cutter 300, illustrated in FIG. 16 a blade storage area 302 may be integrated into the housing of the cutter so that additional blades may be kept and interchanged during operation. A latch 304, door, plug, or other means may be used to secure the additional blades within the storage area.

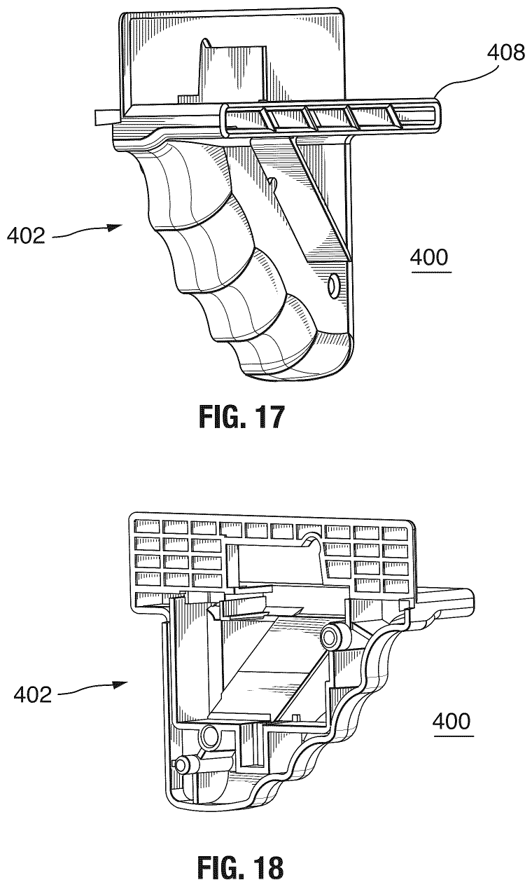

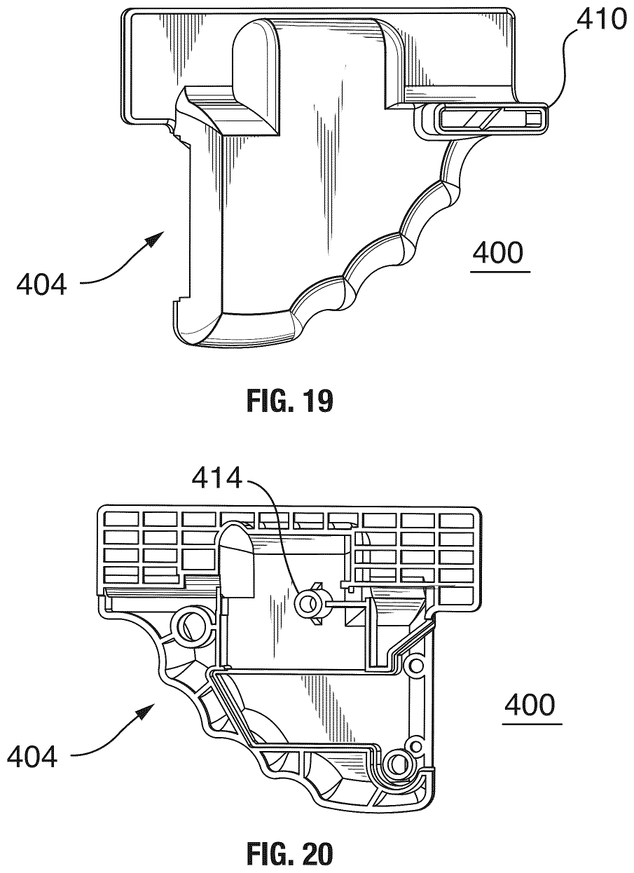

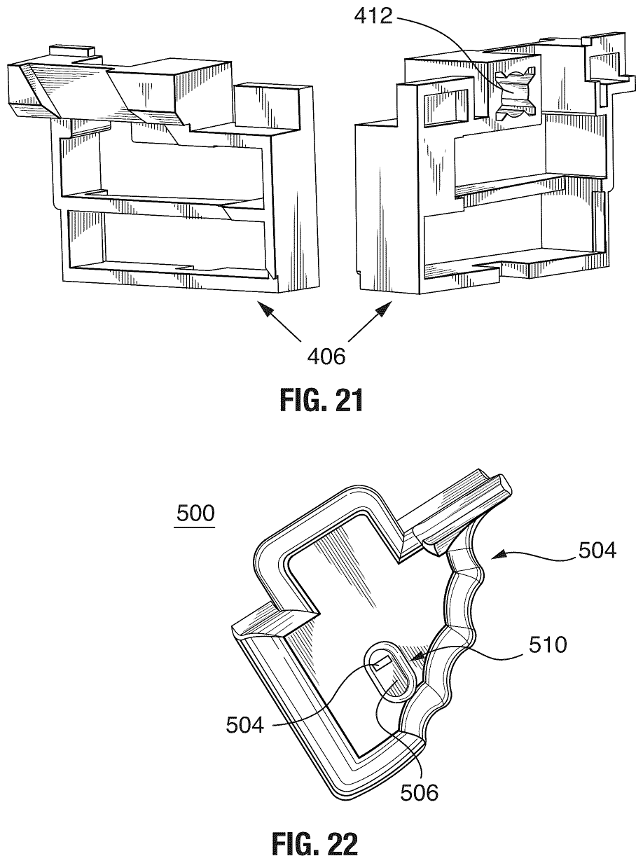

In a third embodiment of the dual-action safety box cutter 400, the top cover 402, bottom cover 404 and safety box 406 are optimized for injection molding processes. As illustrated in FIGS. 17-21, the top cover and bottom cover are shelled to have a uniform wall thickness and include ribs and gussets to increase rigidity and strength. Externally, elements needing additional structural rigidity are thickened, including the base 408 and the thumb rest 410. The safety box 406 is also shelled to maintain uniform wall thicknesses and includes a star-shaped recess 412 for receiving a gusseted boss 414 on the bottom cover 404 which can be used to locate the safety box or secure the safety box into place.

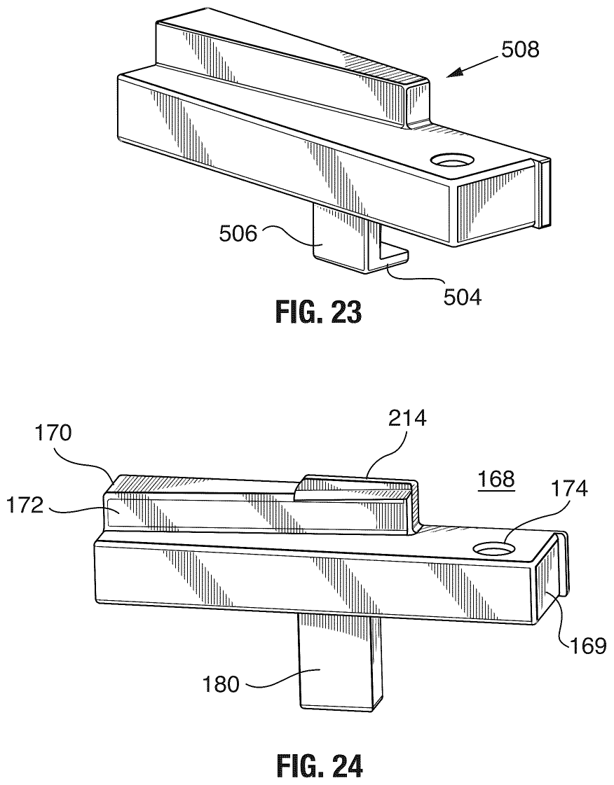

In a fourth embodiment of the dual-action safety box cutter 500, illustrated in FIGS. 22-23, a safety override may be implemented so that a user may manually disengage the safety mechanism. A pull tab 504 may extend perpendicularly from the guide rod 506 of the safety jam 508 to allow a user to manually compress the compression spring 178 and thereby allow the movable blade guard to rotate inward even when a box is not registered against the base and fence of the cutter. The pull tab 504 may be access through a port 510 located on the back cover 512.

In an alternative embodiment of the dual-action safety box cutter 100, the catch 170 of the safety jam 168 may additionally include a close-assist projection 214 protruding from its top surface. The close-assist projection 214 provides a biasing force against the inner, bottom edge 216 (denoted in FIG. 4) of the bottom arm 150 of the movable blade guard 112 to contribute to its outward rotation. With the addition of the close-assist projection, the movable blade guard is not only rotated outward by the torsion spring 158, but also the force supplied by the compression spring 178. In an additional alternative embodiment, the bottom arm 150 of the movable blade guard 112 may have a chamfer that allows the outward rotational force exerted on the movable blade guard to be supplied totally by the compression spring 178.

The disclosure has been described with reference to various specific embodiments and techniques. However, it should be understood that many variations and modifications may be made while remaining within the spirit and scope of the invention. It is therefore appreciated that certain features of the invention, which are, for clarity, described in the context of separate embodiments, may also be provided in combination in a single embodiment. Conversely, various features of the invention that are, for brevity, described in the context of a single embodiment, may also be provided separately or in any sub-combination.

I claim:

1. A box cutter for cutting a box comprising a blade, a housing, and a dual-action safety mechanism,
said housing having a base and a fence for registering against the edge of a box and a handle extending from the back side of said base,
said blade protruding from said base with a sharp edge of the blade oriented towards a direction of motion of the cutter, and
said dual-action safety mechanism comprising a movable blade guard which protrudes and rotates outward from the fence of the housing, a guard-release button which protrudes from the base of the housing, and a mechanism linking the movable blade guard and guard-release button which prevents the rotation of the movable blade guard away from the blade unless the guard-released button is depressed.

2. The box cutter of claim 1 wherein the mechanism linking the movable blade guard further includes a safety jam having a catch which, when the guard-release button is released, impedes the inward rotational motion of the movable blade guard so that the blade remains sheathed.

3. The box cutter of claim 2 wherein the safety jam and catch are continuously and automatically biased upwards in an impeding configuration due to a spring positioned beneath the safety jam, said spring being compressed by the guard-release button during operation of the box cutter, thereby allowing the movable blade guard to be inwardly rotated into the housing to reveal the blade.

4. The box cutter of claim 1 wherein the guard-release button is positioned on the base of the housing in front of the blade relative to the direction of motion.

5. The box cutter of claim 1 wherein the movable blade guard includes a ramped section protruding from the fence of the housing, providing a biasing surface for the box to rotate the guard into the housing of the cutter when the safety mechanism is disengaged.

6. The box cutter of claim 1 wherein a torsion spring secured to a base of the movable blade guard provides the biasing force necessary to rotate the movable blade guard outward to shield the blade.

7. The box cutter of claim 1 wherein a blade-shaped recess holding the blade in a proper position on the base has at least one alignment pin for interacting with an at least one alignment groove in the blade so a cutting depth of the blade can be adjusted by a user.

8. The box cutter of claim 1 further including a blade storage compartment in the housing.

9. The box cutter of claim 1 having a slot in the housing for interacting with a safety mechanism override switch.

10. The box cutter of claim 1 wherein said handle is configured to fit into the palm of a user's hand, allowing the user to apply force to the cutter using their large muscle groups.

11. A method of cutting a box comprising:
a box cutter comprising a blade, a housing, and a dual-action safety mechanism,
said housing having a base and a fence for registering against the edge of the box and a handle extending from the back side of said base,
said blade protruding from said base with a sharp edge of the blade oriented towards a direction of motion of the cutter, and
said dual-action safety mechanism comprising a movable blade guard which protrudes and rotates outward from the fence of the housing, a guard-release button which protrudes from the base of the housing, and a mechanism linking the movable blade guard and guard-release button which prevents the rotation of the movable blade guard away from the blade unless the guard-released button is depressed;
wherein the base and fence of the cutter are registered against an edge of the box, at a leading end of the cutter relative to the direction of motion of the cutter;
the cutter is pulled along the edge of the box until the guard-release button is depressed and disengages the safety mechanism;
the cutter is further pulled along the edge of the box until the box interacts with the movable blade guard of the cutter, causing the movable blade guard to rotate inwards into the housing, thereby revealing the blade;
and completing the cut by pulling the cutter through the edge of the box until a desired length of cut has been made.

12. The method of claim 11 further including the step of inserting the blade into a blade-shaped recess formed into the cover of the housing of the box cutter.

13. The method of claim 12 further including the step of adjusting a cutting depth of the blade by aligning at least one alignment groove of the blade with an at least one alignment pin of the blade-shaped recess.

14. The method of claim 11 further including the step of securing the blade into the blade-shaped recess by attaching a blade cover over the blade-shaped recess and fastening the blade cover into place using fastening means.

15. The method of claim 14 wherein said fastening means is a threaded thumb screw.

16. The method of claim 15 wherein said handle is configured to fit into the palm of a user's hand, allowing the user to apply force to the cutter using their large muscle groups.

17. A box cutter for opening a box, comprising:
a housing;
a blade cover, wherein the housing comprises a blade-shaped recess to accommodate a blade and over which the blade cover can be attached;
a movable blade guard which varies between a locked position that covers potions of the blade external to the housing, and an unlocked position where at least a portion of the blade is exposed for cutting;
a biasing member that applies a biasing force to the movable blade guard and biases the blade guard to blade-sheathing position; and
a guard-release button that when depressed allows the movable blade guard to move to an unlocked position.

18. The box cutter of claim 17 wherein the blade recess includes at least one projection to position the blade at different depths within the blade-shaped recess.

19. The box cutter of claim 17 wherein the biasing member is a torsion spring.

20. The box cutter of claim 17 wherein the biasing member is primarily a torsion spring which is further supplemented by a compression spring applying a second biasing force to bias the movable blade guard to the blade-sheathing position.
